(19) United States
(12) Patent Application Publication
(10) Pub. No.: US 2015/0050561 A1
(43) Pub. Date: Feb. 19, 2015

(54) HIGH VOLTAGE LITHIUM ION BATTERIES HAVING FLUORINATED ELECTROLYTES AND LITHIUM-BASED ADDITIVES

(71) Applicant: UChicago Argonne, LLC, Chicago, IL (US)

(72) Inventors: Zhengcheng Zhang, Naperville, IL (US); Libo Hu, Willowbrook, IL (US); Khalil Amine, Oakbrook, IL (US); Christopher S. Johnson, Naperville, IL (US)

(73) Assignee: UChicago Argonne, LLC, Chicago, IL (US)

(21) Appl. No.: 13/969,134

(22) Filed: Aug. 16, 2013

(51) Int. Cl. H01M 10/0569; H01M 10/0525

(52) U.S. Cl. CPC H01M 10/0569; H01M 10/0525
USPC 429/332; 429/337; 429/338; 429/342; 429/343; 429/341

(57) ABSTRACT

A lithium ion cell includes a cathode including a cathode active material having an operating voltage of 4.6 volts or greater; an anode including an anode material and a lithium additive including a lithium metal foil, lithium alloy, or an organolithium material; a separator; and an electrolyte.

### GOVERNMENT RIGHTS

The United States Government has rights in this invention pursuant to Contract No. DE-AC02-06CH11357 between the U.S. Department of Energy and UChicago Argonne, LLC, representing Argonne National Laboratory.

### FIELD

The present technology is generally related to lithium ion batteries having high voltage electrodes. More specifically it is related to high voltage lithium battery with stable electrolytes that enable cell operation at both room temperature and high temperatures.

### BACKGROUND

Lithium ion batteries having high energy density and high voltage are commercially available and widely used as electrical power for consumer electronics, medical, military and vehicles. The electrolyte used in lithium-ion batteries is a key factor influencing the performance of the cell. To further enhance the energy and power density of the lithium ion cells, high voltage cathode materials were developed to provide cells with discharge potential greater than 4.5 V vs. Li/Li⁺. However, during the charging process of these cells the electrolyte is frequently exposed to potentials higher than 4.8 V, at which the electrolyte may encounter severe decomposition, leading to rapid fading of the cell capacity, and as a result, greatly shortened cycle life.

Additionally, for many applications, batteries are expected to operate at elevated temperatures. Under such conditions the solid electrolyte interface (SEI) on the anode is prone to decompose, leading to further decomposition of the electrolyte on the anode surface. This decomposition also leads to rapid fading of capacity of the cell and short cycle lifetimes.

Attempts have been made to identify an electrolyte system that can resist oxidation beyond 5.0 V, and unsymmetrical sulfones were shown provide such a system with a spinel LiMn₂O₄ surface (K. Xu, et al., J. Electrochem. Soc., 1998, Vol. 145, L70; J. Electrochem. Soc., 2002, Vol. 149, A920). However, intrinsic shortcomings of sulfone as a major electrolyte component, including its failure to form a protective layer on graphitic anodes, slow Li ion kinetics, and poor electrode active material utilization caused by high viscosity, have prevented wide application.

Additional improvements have been made with respect to mitigating the oxidizing nature on the cathode surfaces by using surface coatings. Various metal oxides or phosphates were shown to be effective in extending the service life of the carbonate-based electrolytes (J. Liu, et al., Chem. Mater, 2009, Vol. 21, 1695). However, such coatings have their own intrinsic shortcomings as well. They not only add additional cost to the manufacturing of the cathode materials, but also induce further interphasial resistance to the Li ion migration at electrolyte/cathode junction. Moreover, overall coverage of cathode particle surface with those inert coatings will inevitably decrease the energy density of the device.

It is therefore of significant interest to the battery industry to find a technology that can effectively enable the 5.0 V class cathode to be applied in Li ion batteries, without the aforementioned shortcomings

### SUMMARY

In one aspect, lithium ion batteries are provided having high voltage electrodes. The batteries have stable electrolytes that enable cell operation at both room temperature and high temperatures.

In another aspect, a lithium ion cell includes a cathode including a cathode active material having an operating voltage of 4.6 volts or greater; an anode including an anode material; and a lithium additive including a lithium metal foil, lithium alloy, or an organolithium material; or a cathode active material having a excess stoichiometric amount of lithium, or a sacrificial cathode active material; a separator; and an electrolyte. The lithium additive may be considered to a lithium reservoir, providing a excess amount of lithium to support high voltage operation. In one embodiment, the cathode active material has an operating voltage from 4.6 volts to 5.3 volts. In one embodiment, the cathode active material has an operating voltage from 4.8 volts to 5.2 volts. In one embodiment, the cathode active material has an operating voltage from 4.9 volts to 5.2 volts.

In another aspect, a lithium ion cell includes a cathode including a cathode active material having an operating voltage of 4.6 volts or greater; an anode including an anode material; a lithium additive; a separator; and an electrolyte including a lithium salt and a fluorinated solvent. The lithium additive may be a lithium metal foil, a lithium alloy, an organolithium material, the cathode active material having an excess stoichiometric amount of lithium, a sacrificial cathode active material. By “excess stoichiometric amount of lithium” it is meant that the lithium additive may be the cathodic material itself, where more than a stoichiometric amount of lithium is present in the cathodic material. By “sacrificial cathode active material” it is mean that it is a material which is cathode active, but irreversible, thereby contributing lithium to the system. Examples of sacrificial cathode active materials include, but are not limited to Li₂MnO₃, Li₅FeO₄, and Li_{x′}(Met)O₂, wherein Met is a transition metal and 1<x′≦2. In some embodiments, Met is Ni, Co, Mn, or a mixture thereof.

The fluorinated solvent of the electrolyte of such cells may be represented by Formula I, II, III or IV:

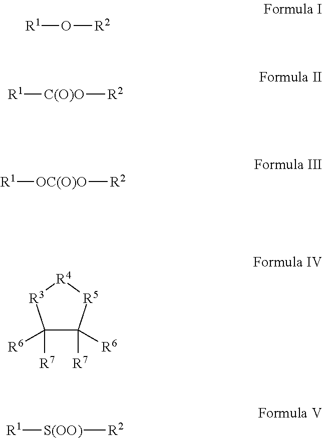

In Formulas I, II, III, IV, and V, R¹ and R² are individually an alkyl or CₙHₓF_{y} group; R³ and R⁵ are individually O or CR⁶R⁷; R⁴ is O or C═O; each R⁶ and R⁷ is individually H, F or a CₙHₓF_{y} group; each x is individually from 0 to 2n; each y is individually from 1 to 2n+1; and each n is individually an integer from 1 to 20. The Formulas are also subject to the provisos that at least one of R¹ and R² is a CₙHₓF_{y} group; at least one R⁶ or R⁷ is other than H, and R⁴ is not O when R³ or R⁵ is O. In one embodiment, the electrolyte includes fluoroethylene carbonate, methyl 2,2,2-trifluoroethyl carbonate, and 1,1,2,2-tetrafluoroethyl-2,2,3,3-tetrafluoropropyl ether in a volume ratio of 3:5:2. by volume.

In some embodiments, the anode includes the organolithium compound. In another embodiment, the anode includes a lithium metal foil.

### BRIEF DESCRIPTION OF THE DRAWINGS

FIG. 1 is an illustration of a cell assembly for lithiation of an anode during initial charge and discharge, according to one embodiment.

FIG. 2 is a capacity retention (%) v. cycle number graph for cells prepared with and without lithium metal as an additive, according to Example 1.

FIG. 3 is a capacity (mAh/g) v. cycle number graph for cells prepared with and without lithium metal as an additive, according to Example 1. The non-lithiated cells were cycled from 3.5 V to 4.8 V at a current of C/3 at 55° C. The lithiated cells were cycled from 3.5 V to 4.8 V at a current of C/2 at 55° C.

FIG. 4 is a capacity retention (%) v. cycle number graph for cells prepared with and without lithium metal as an additive, according to Example 2.

FIG. 5 is a capacity (mAh/g) v. cycle number graph for cells prepared with and without lithium metal as an additive, according to Example 2. The cells were cycled from 3.5 V to 4.9 V at a current of C/3 at 55° C.

FIG. 6 is an illustration of a cell assembly for lithiation of an anode, according to one embodiment.

FIG. 7 is a capacity retention (%) v. cycle number graph for a cells prepared with and without lithium metal as an additive, according to Example 3.

FIG. 8 is a capacity (mAh/g) v. cycle number graph for a re-built cells using additional lithium metal as an additive, according to Example 4.

FIG. 9 is a graph of capacity v. cycle number for a cell, according to Example 5.

FIG. 10 is a graph of capacity v. cycle number for a cell, according to Example 6.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

It has been found that rapid loss in capacity of lithium ion batteries under high voltage and/or high temperature conditions are due, at least in part, to decomposition reactions in the electrolyte during battery operation that consume lithium, thereby depleting the available lithium in the battery. In other words, during battery charging and discharging, the active lithium in the battery system is slowly consumed by the decomposition of the electrolyte. Such decomposition and lithium depletion is irreversible. To combat this, in one aspect, provided is a method of using lithium metal or a lithium compound (i.e. a lithium additive, or in other words, a lithium reservoir) in conjunction with an anode, to enhance the cycle life of lithium ion batteries. Such methods, the anodes, and devices incorporating them, are especially useful when the cell is to be used at elevated temperatures and/or with high voltage cathodes. Additionally, electrolytes with intrinsic oxidation stability which can be incorporated into the high voltage cells to support the reversible Li⁺ intercalation/deintercalation chemistry at potentials above 4.5 V. In one embodiment, this is accomplished using fluorinated solvents.

The high voltage electrolytes provided herein go beyond merely battery applications and may provide benefit any electrochemical devices that pursue higher operating potentials. The presence of the high voltage electrolyte/active lithium additives may enable long term cycle life of the high voltage cell at room temperature and elevated temperatures. Such electrochemical devices include, but not limited to, rechargeable batteries, double layer capacitors, pseudo-capacitors, electrolytic cells and fuel cells.

The batteries or the electrochemical devices may include an anode with intercalation an host such as layered structured materials of graphitic, carbonaceous, oxide or silicon, silicon-carbon composite, tin and tin alloys; a cathode such as an intercalation host based on metal oxides, phosphates, fluorides or other chemical natures or non-intercalated hosts of high surface areas or high pseudo-capacitance; and an electrolyte as described herein.

In one aspect is provided a lithium ion cell that includes a cathode having an operating voltage of 4.6 volts or greater, an anode, and a lithium additive. The anode may be an anode material or an intercalation material. The lithium additive may be lithium metal source, such as a lithium foil, lithium metal powder, a lithium alloy or an organolithium compound. Alternatively, cathode may contain a larger than stoichiometric amount of lithium in the cathode active material, which will then act as a lithium additive for the cell. In yet another alternative, the cathode material may contain a sacrificial cathode active material, which will also act as a lithium additive for the cell. The cells also include a separator and an electrolyte.

As noted, the cells are intended for high voltage applications. Thus, in some embodiments, the cathode has an operating voltage of greater than about 4.8 volts, or greater than about 5.0 volts. This includes from about 4.6 to about 5.3 volts, from about 4.8 to about 5.2 volts, or from about 4.9 to about 4.2 volts.

Illustrative cathode materials that may achieve such high voltages include those of Formula Liₓ(M¹_{y}Mn_{2-y})O₄, Liₙ(M²_{y}M³_{2-y}(XO₄)₃, LiM²_{z}M³_{1-z}XO₄, or LiM²_{z}M³_{1-z}ZO₄LiR¹ₐR²₁₋ₐ. In such cathode materials, M¹ may be Cr, Fe, Co, Ni, or Cu, M² may be Fe, Co, Mn, Ti, V, or Ni, M³ is different from M² and may be Fe, Co, Mn, Ti, V, or Ni, X is S, P, As, Mo or W, Z may be P or S, R¹ may be O, OH, F, Cl, Br or I, R² is different from R¹ and may be O, OH, F, Cl, Br or I, 0<x≦2, 0<y<2, 0<z<1, 0≦n≦3, and 0≦a≦1. Illustrative cathode materials include, but are not limited to, LiCr_{0.5}Mn_{1.5}O₄, LiCrMnO₄, LiFe_{0.5}Mn_{1.5}O₄, LiCo_{0.5}Mn_{1.5}O₄, LiCoMnO₄, LiCoMnO₄, LiNi_{0.5}Mn_{1.5}O₄, LiNiPO₄, LiCoPO₄, LiMnPO₄, and LiCoPO₄F. In some embodiments, the cathode active material is LiMn_{0.33}Fe_{0.33}Co_{0.33}PO₄, Li_{2.02}Co_{0.64}Mn_{3.34}O₈, or LiCoSO₄F. In other embodiments, 1<x≦2, which represents a cathode containing a surplus of lithium in the structure, wherein the lithium additive comprises a sacrificial cathode active material selected from the group consisting of Li₂MnO₃, Li₅FeO₄, and Li_{x′}(M)O₂, wherein M includes Ni, Co, Mn, and 1<x′≦2.

In some embodiments, the high voltage cathode active material is Liₓ(M¹_{y}Mn_{2-y})O₄, where x=2. In such compounds, the cathode active material is actually “overlithiated” having more than the required amount of lithium to be an active material. The overlithiated Li₂(M¹_{y}Mn_{2-y})O₄ may be prepared by reacting Liₓ(M¹_{y}Mn_{2-y})O₄ with a lithium halide (e.g. LiCl, LiBr, or LiI) or with a lithium foil at stoichiometric ratios, or it may be prepared electrochemically in a cathode/Li half-cell. For example, a overlithiated Liₓ(M¹_{y}Mn_{2-y})O₄, where M¹ is Ni, y=0.5, and x=2, may be prepared according to reaction (1):

LiI+LiNi_{0.5}Mn_{1.5}O₄→Li₂Ni_{0.5}Mn_{1.5}O₄ (1)

Alternatively, it may be prepared by the electrochemical process illustrated in reactions (2) and (3):

Li→Li⁺+e⁻ (2)

LiNi_{0.5}Mn_{1.5}O₄+Li⁺+e→Li₂Ni_{0.5}Mn_{1.5}O₄ (3)

The excess lithium in the overlithiated cathode will be released during the initial charging process, and will be stored in the anode side. Further charging the cell will result in a regular charging of the high voltage non-overlithiated cathode thus providing extended cycle life of the battery, especially at elevated temperature.

As noted above, a sacrificial cathode material may also be used as a lithium additive. Such sacrificial cathode materials include, but are not limited to, Li₂MnO₃, Li₅FeO₄, and Li_{x′}(Met)O₂, wherein Met is a transition metal and 1<x′≦2. In some embodiments, Met is Ni, Co, Mn, or a mixture of any two or more thereof. In some embodiments, Met is a mixture of Ni, Co, and Mn.

The anodic materials may include carbon materials, silicon materials, or alloy-forming materials. For example, illustrative carbon materials include, but are not limited to, synthetic graphite, carbon-coated natural graphite, hard carbon, soft carbon, or mesocarbon microbeads (MCMB). Illustrative silicon materials include, but are not limited to, silicon, silicon/carbon fiber composites, silicon/graphene composite, and SiOx (silicon oxide). Illustrative alloy-forming materials include, but are not limited to, CoSn and Cu₆Sn₅.

The lithium additive material, as noted above, may include lithium metal foil, lithium metal particles, a lithium alloy, or an organolithium compound. Illustrative lithium alloys include, but are not limited to, Li_{b}Si, Li_{b}Al, Li_{b}Sn, and Li_{b}Sb. The b in such values merely refers to the alloying of the lithium with the other element. In some embodiments, b is from 1 to 4.2. For example, for LiₓSi and LiₓSn, b may from 1 to about 4.2. In some such embodiments, b is from 4 to 4.2. In LiₓAl and LiₓSb, b may be from 1 to 3. In some such embodiments, b may be about 3.

The amount of the lithium additive material is present in the cell at a capacity of about 100% to about 300% of the cathode capacity.

The lithium metal foils or alloys may reside within the housing of the cells, and so too may the organolithium materials when used. For example, the organolithium materials may be added to the electrolyte. Illustrative organolithium compounds may include, but are not limited to, lithium terephthalate carboxylate (1), lithium isatine (2), dilithium pyromellitic diimide (3), tetralithium salt of tetrahydroxybenzoquinone (Li₄C₆O₆) (4), and aryl lithium:

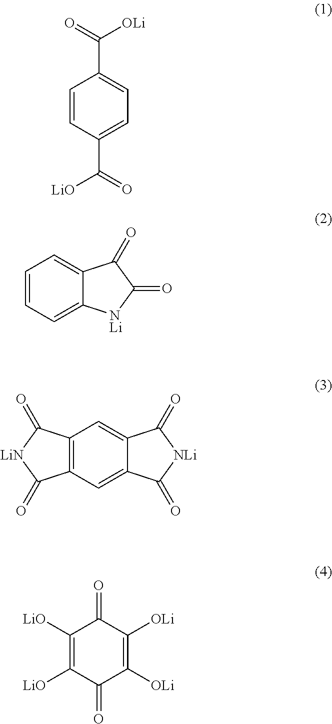

Illustrative organolithium compounds include, but are not limited to, 2-(phenylsulfonyl)-propan-2-yl lithium, 2-(phenylsulfinyl)-propan-2-yl lithium, 2-cyanopropan-2-yl lithium, 2-(diethoxyphosphoryl)propan-2-yl lithium, lithium-2-carboxylatopropan-2-yl lithium, furanyl lithium, thiophenyl lithium, lithium diisopropylamine, lithium bis(trimethylsilyl)amide, and lithium tetramethylpiperidide.

The anodes of the lithium ion cells also include a current collector. The current collector has an obverse surface and a reverse surface. Where the anodic material may be associated with either the obverse or the reverse surface, or both the designation is used to illustrate placement of the lithium additive material, where the material is a lithium metal foil or lithium metal particles. For example, where the anodic material is in contact with the obverse surface, the lithium metal foil, particulate, or powder may be proximal to the reverse surface. Or, in other words, on the opposite face of the current collector from the anodic material. Alternatively, where the anodic material is in contact with the obverse surface, the lithium metal foil may be proximal to the anodic material. Or, in other words, sandwiched between the anodic material and a separator prior to the cathode.

The cathodes of the lithium ion cells also include a current collector. Current collectors for either the anode or the cathode may include those of copper, stainless steel, titanium, tantalum, platinum, gold, aluminum, nickel, cobalt nickel alloy, highly alloyed ferritic stainless steel containing molybdenum and chromium; or nickel-, chromium-, or molybdenum-containing alloys.

The electrolytes of the cells may include a non-aqueous polar solvent and a lithium salt. The solvent and the lithium salt are not particularly limited, however they will be robust enough to withstand the high voltages of the cell and not degrade at such voltages. For example, illustrative lithium salts include, but are not limited to, LiPF₆, LiClO₄, Li(CF₃SO₂)₂N, LiC(SO₂CF₃)₃, (Li(C₂F₅SO₂)₂N), LiCF₃SO₃, Li₂B₁₂X₁₂₋ₙHₙ, Li₂B₁₀X_{10-n′}H_{n′}, where X is a halogen, n is an integer from 0 to 12, and n′ is an integer from 0 to 10, LiAlF₄, LiBF₄, Li(FSO₂)₂N, Li₂SO₄, and LiAsF₆. Illustrative solvents include, but are not limited to, ethylene carbonate (EC), dimethylcarbonate (DMC), diethylcarbonate (DEC), ethylmethylcarbonate (EMC), propylene carbonate (PC), and a fluorinated solvent. Illustrative fluorinated solvents include those represented by Formula I, II, III or IV:

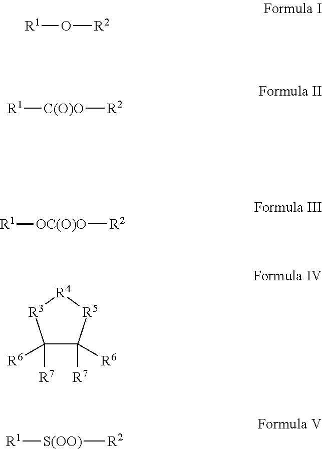

In Formulas I, II, III, IV, and V, R¹ and R² are individually a an alkyl or CₙHₓF_{y} group; R³ and R⁵ are individually O or CR⁶R⁷; R⁴ is O or C═O; each R⁶ and R⁷ is individually H, F or a CₙHₓF_{y} group; each x is individually from 0 to 2n; each y is individually from 1 to 2n+1; and each n is individually an integer from 1 to 20. However, the formulae are also subject to the following provisos: at least one of R¹ and R² is a CₙHₓF_{y} group; at least one R⁶ or R⁷ is other than H, and R⁴ is not O when R³ or R⁵ is O.

In some embodiments, R¹ and R² are individually CF₂CF₃; CF₂CHF₂; CF₂CH₂F; CF₂CH₃; CF₂CF₂CF₃; CF₂CF₂CHF₂; CF₂CF₂CH₂F; CF₂CF₂CH₃; CF₂CF₂CF₂CF₃; CF₂CF₂CF₂CHF₂; CF₂CF₂CF₂CH₂F; CF₂CF₂CF₂CH₃; CF₂CF₂CF₂CF₂CF₃; CF₂CF₂CF₂CF₂CHF₂; CF₂CF₂CF₂CF₂CH₂F; CF₂CF₂CF₂CF₂CH₃; or CF₂CF₂OCF₃. In some embodiments, the fluorinated solvent includes CHF₂CF₂OCF₂CF₂CF₂H;

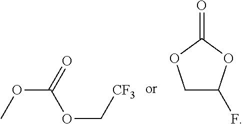

In another aspect, a process for producing a lithium ion cell anode is provided. The process includes applying an anode material to an obverse surface of a current collector; and contacting a lithium metal foil with a reverse surface of the current collector or to a surface of the anode material. In some embodiments, the process includes contacting the lithium metal foil the reverse surface of the current collector. In some embodiments, the applying includes binding the anodic active material to the obverse surface with a binder. Illustrative binders include, but are not limited to, polyvinylidene difluoride (PVDF), polyvinyl alcohol (PVA), polyethylene, polystyrene, polyethylene oxide, polytetrafluoroethylene (Teflon), polyacrylonitrile, polyimide, styrene butadiene rubber (SBR), carboxy methyl cellulose (CMC), alginate, gelatine, a copolymer of any two or more such polymers, or a blend of any two or more such polymers.

In another aspect, a process is provided for producing a high voltage lithium ion cell. The process includes, preparing an anode by applying an anode material to an obverse surface of a current collector; and contacting a lithium metal foil, powder, or particulate with a reverse surface of the current collector or with the anode material. In some embodiments, the lithium metal foil, powder, or particulate is contacted with a reverse surface of the current collector. The process also include introducing the anode separated from a cathode by a separator into a lithium ion battery housing; introducing an electrolyte into the housing; and sealing the housing to form the high voltage lithium ion cell. As noted above, the high voltage lithium ion cells have an operating voltage of greater than 4.6 volts. In some embodiments, the high voltage lithium ion cells have an operating voltage of greater than 4.8 volts. wherein: the cathode active material has an operating voltage of 4.8 volts or greater. This may include from about 4.8 volts to about 6.0 volts, from about 4.8 volts to about 5.2 volts. Or from 4.9 volts to 5.2 volts.

In another aspect, a process is provided for regenerating a lithium ion cell. After a lithium cell has diminished in capacity, the capacity may be restored as according to the following procedure. The process includes disassembling the cell under an inert atmosphere, placing a small amount of lithium into the cell proximal to an anode current collector, and re-assembling the cell. The lithium may be a lithium metal foil that is placed either behind the anode or between the anode material and a separator. Contact between the anode and the lithium metal ensures rapid regeneration of the cell.

The present invention, thus generally described, will be understood more readily by reference to the following examples, which are provided by way of illustration and are not intended to be limiting of the present invention.

### EXAMPLES

### Example 1

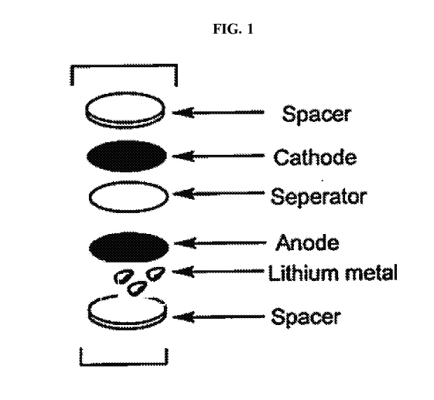

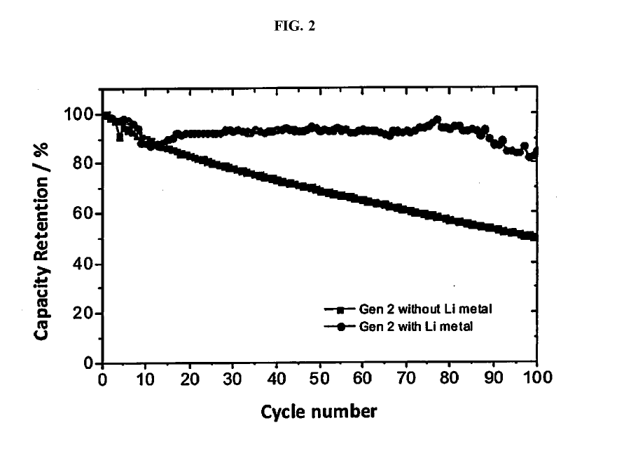

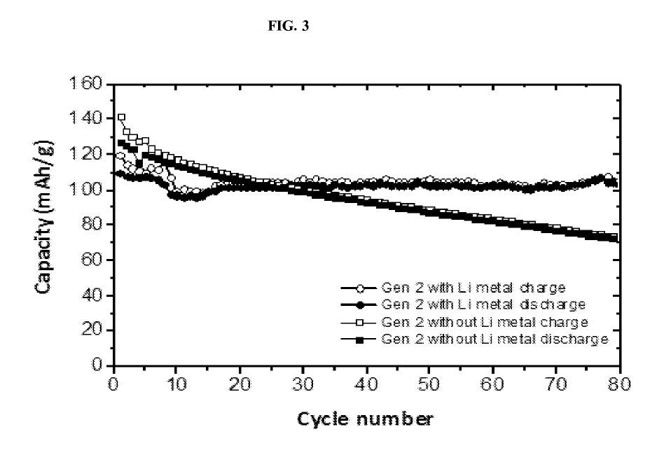

Using a metallic lithiated anode with a conventional electrolyte. An A12 graphite anode (3.2 mAh) and a LiN_{0.5}Mn_{1.5}O₄ cathode (1.2 mAh) were used as an electrode couple to assemble a full cell using 3:7 (vol:vol) ethylene carbonate:ethylmethylcarbonate with 1.0 M LiPF₆ as an electrolyte. Prior to cell assembly, approximately 1 mg of lithium metal fragments was placed in between a copper foil current collector of the anode and the spacer on the anode side and two drops of electrolyte were added in between the copper foil and the spacer. This is illustrated in FIG. 1. Otherwise, the cell was assembled following the standard procedure. The full cell was then subjected to cycling from 3.5V to 4.8V at 55° C. with a rate of C/2. A comparative example (without lithiation) employed the same anode, cathode, and electrolyte and cycling conditions. FIG. 2 is an illustration of the capacity retention of a cell with electrolyte (“Gen 2”) both with and without lithium metal from 3.5 V to 4.8 V with a C/2 rate at 55° C. FIG. 3 is a graph of the capacity during charge and discharge for the batteries with and without lithium metal, under the same conditions as for FIG. 2.

Without being bound by theory, it is believed that during the initial charging process, the lithium ion in the cathode material migrates from the cathode and is intercalated into the graphite anode. At this stage, the lithium metal is shorted with the anode and the anode potential would remain at 0 V vs. Li/Li⁺ and would not change. After the initial charging is completed, the first discharge would start with the lithium metal first due to its lower potential than the lithiated graphite. The graphite then begins to delithiate until the lithium metal is fully discharged, or until the metal is no longer in contact with the electrolyte solution. The ideal net result after the first discharge is that the cathode is fully re-lithiated, the graphite is partially delithiated and the lithium metal is fully discharged and/or dissolved. However, in reality, the lithium metal may not be fully discharged in the first cycle but it will slowly discharge and/or dissolve over future cycles due to its low reduction potential, which is discharged first.

### Example 2

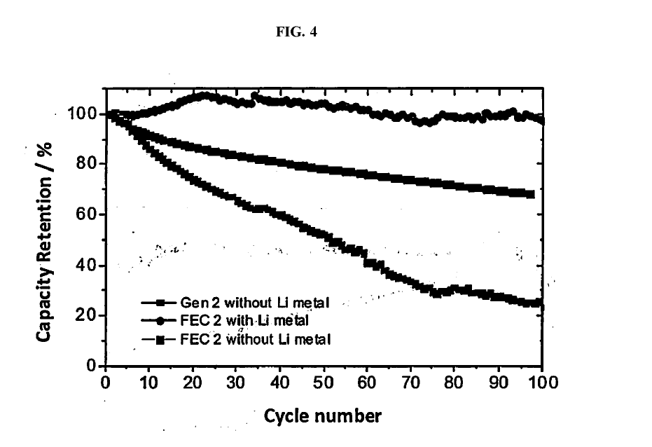

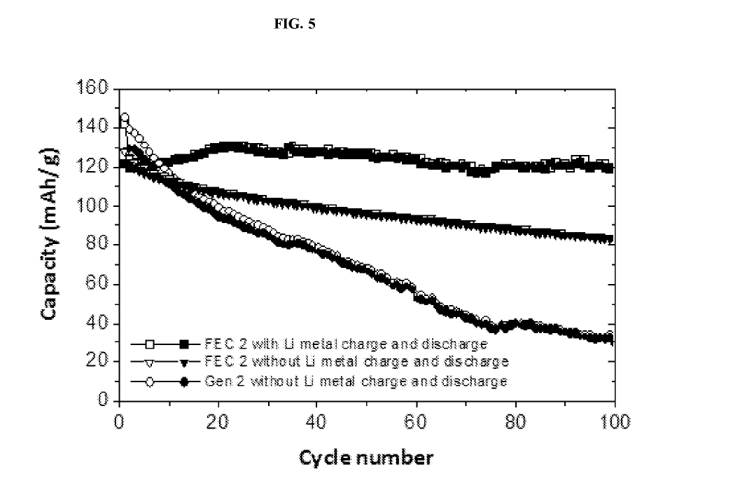

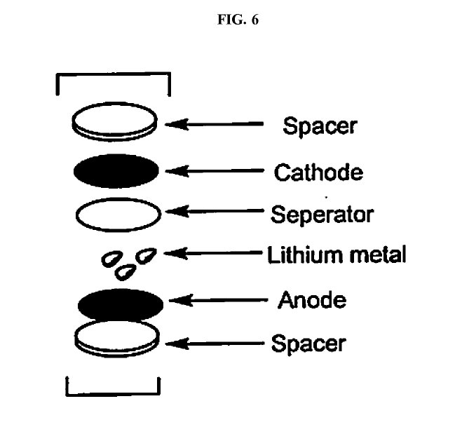

Using a metallic lithiated anode with a non-conventional electrolyte. An A12 graphite anode (3.2 mAh) and a LiN_{0.5}Mn_{1.5}O₄ cathode (2.6 mAh) were used as an electrode couple to assemble a full cell using an electrolyte containing fluorinated carbonates and ethers: 1.0M LiPF₆ in fluoroethylene carbonate (FEC), methyl 2,2,2-trifluoroethyl carbonate (F-EMC), and 1,1,2,2-tetrafluoroethyl-2,2,3,3-tetrafluoropropyl ether (F-EPE) in a volume ratio of 3:5:2. by volume. The cell was otherwise assembled as the cell in Example 1. The full cell was then subjected to cycling from 3.5V to 4.9V at 55° C. at a rate of C/3. A first comparative example used the same anode, cathode, electrolyte and cycling conditions but without the added lithium metal. A second comparative example using an electrolyte of 3:7 (vol:vol) ethylene carbonate:ethylmethylcarbonate with 1.0 M LiPF₆ was also used. FIG. 5 is an illustration of the capacity retention of a cell with electrolyte (“Gen 2” or “FEC”) both with and without lithium metal from 3.5 V to 4.9 V with a C/3 rate at 55° C. FIG. 6 is a graph of the capacity during charge and discharge for the batteries with and without lithium metal, under the same conditions as for FIG. 4.

### Example 3

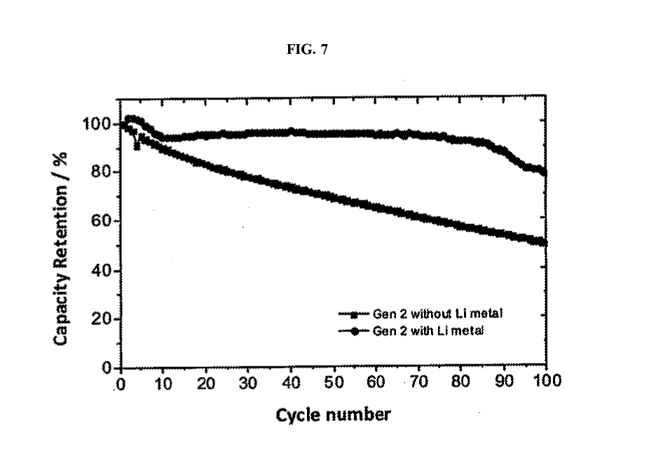

Using a lithium metal directly on an anode. As an alternative to the procedure described in Examples 1 and 2, the anode can be directly lithiated by pressing the lithium metal directly onto the graphite anode surface. An A12 graphite anode (3.2 mAh) and a LiN_{0.5}Mn_{1.5}O₄ cathode (1.2 mAh) were used as an electrode couple to assemble a full cell using 3:7 (vol:vol) ethylene carbonate:ethylmethylcarbonate with 1.0 M LiPF₆ as an electrolyte. During cell assembly, the anode was prepared by pressing 1 mg of lithium metal fragments onto the graphite surface of the anode. Otherwise the cell was assembled following standard procedure. The assembly of the cell is illustrated in FIG. 6. The assembled cell was subjected to the same cycling conditions as Example 1, and the result is shown in FIG. 7. A comparative example used the same anode, cathode, electrolyte and cycling conditions but without added lithium metal.

### Example 4

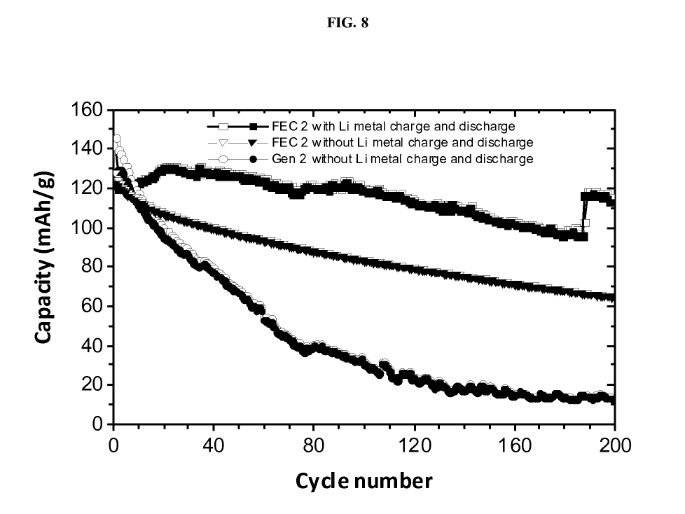

A cell prepared as in Example 2, continued cycling until 188 cycles were complete. At which point the capacity had diminished to approximately 100 mAh/g. The cell was then disassembled, 1 mg of fresh lithium metal was placed behind the anode current collector, and the cell was then re-assembled. The initial drop in capacity after re-assembly is believed to be due to poor contact of the lithium with the electrolyte, but this is recovered after approximately 10 cycles. Continued cycling showed a renewed capacity of the cell. The cycling results are illustrated in FIG. 8.

### Example 5

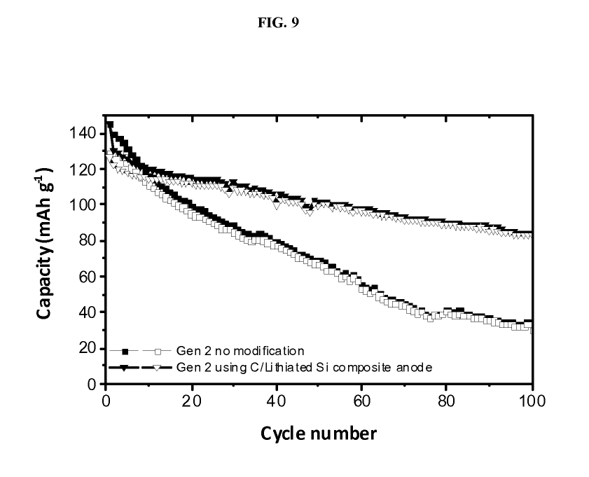

Battery using a lithiated-silicon alloy anode. A lithium silicon alloy anode is prepared by lithiating a silicon anode for 3 cycles of formation with the size of half of a 9/16″ electrode and a capacity of 3.0 mAh. A fresh graphite anode is prepared as the other half of the ‘ 9/16″ electrode to form a composite anode with a capacity of 1.6 mAh. A LiN_{0.5}Mn_{1.5}O₄ cathode (1.6 mAh) was incorporated into the battery with a separator (polypropylene-polyethylene-polypropylene; “PP-PE-PP”; Celgard 2325) disposed between the cathode and the anode. The battery cell was then assembled as a coin cell with electrolyte. The electrolyte used was a 3:7 vol:vol of diethylcarbonate:ethylmethylcarbonate. The capacity of the cell as a function of cycle number is shown in FIG. 9, by comparison to a similarly prepared cell, but using a full graphite anode instead of the composite electrode. The cell with the composite anode shows marked improvement over the standard anode.

### Example 6

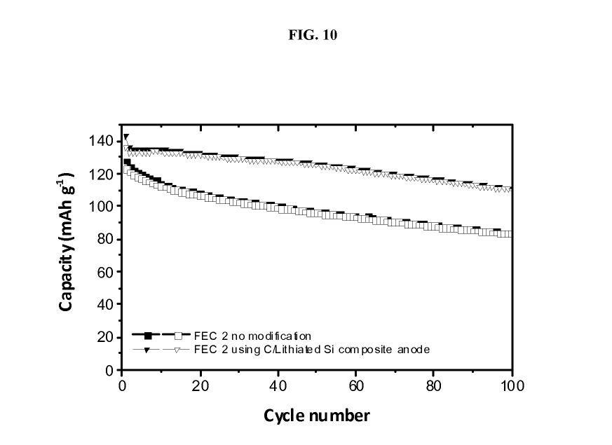

A cell was prepared as in Example 5 but using a fluorinated ether solvent of 1.0M LiPF₆ in fluoroethylene carbonate (FEC), methyl 2,2,2-trifluoroethyl carbonate (F-EMC), and 1,1,2,2-tetrafluoroethyl-2,2,3,3-tetrafluoropropyl ether (F-EPE) in a volume ratio of 3:5:2. by volume. This solvent combination is also referred to as FEC2. The capacity of the cell as a function of cycle number is shown in FIG. 10, by comparison to a similarly prepared cell, but using a full graphite anode instead of the composite electrode. The cell with the composite anode shows marked improvement over the standard anode. Additionally, there is further marked improvement over the conventional carbonate solvents used in Example 5.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A lithium ion cell comprising:
a cathode comprising a cathode active material having an operating voltage of 4.6 volts or greater;
an anode comprising an anode material; and
a lithium additive;
a separator; and
an electrolyte comprising a lithium salt and a fluorinated solvent;
wherein:
the lithium additive comprises a lithium metal foil, a lithium alloy, an organolithium material, the cathode active material having a excess stoichiometric amount of lithium, or a sacrificial cathode active material;
the fluorinated solvent is represented by Formula I, II, III or IV: 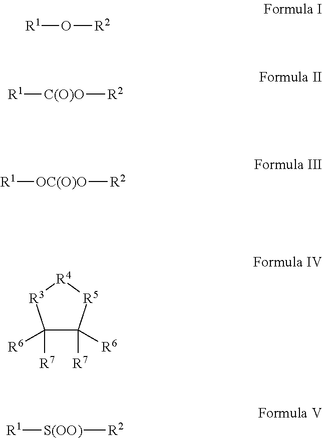
R¹ and R² are individually a an alkyl or CₙHₓF_{y} group;
R³ and R⁵ are individually O or CR⁶R⁷;
R⁴ is O or C═O;
each R⁶ and R⁷ is individually H, F or a CₙHₓF_{y} group;
each x is individually from 0 to 2n;
each y is individually from 1 to 2n+1; and
each n is individually an integer from 1 to 20;
with the proviso that:
at least one of R¹ and R² is a CₙHₓF_{y} group;
at least one R⁶ or R⁷ is other than H, and
R⁴ is not O when R³ or R⁵ is O.

2. The lithium ion cell of claim 1, wherein R¹ and R² are individually CF₂CF₃; CF₂CHF₂; CF₂CH₂F; CF₂CH₃; CF₂CF₂CF₃; CF₂CF₂CHF₂; CF₂CF₂CH₂F; CF₂CF₂CH₃; CF₂CF₂CF₂CF₃; CF₂CF₂CF₂CHF₂; CF₂CF₂CF₂CH₂F; CF₂CF₂CF₂CH₃; CF₂CF₂CF₂CF₂CF₃; CF₂CF₂CF₂CF₂CHF₂; CF₂CF₂CF₂CF₂CH₂F; CF₂CF₂CF₂CF₂CH₃; or CF₂CF₂OCF₃.

3. The lithium ion cell of claim 1, wherein the fluorinated solvent comprises CHF₂CF₂OCF₂CF₂CF₂H;

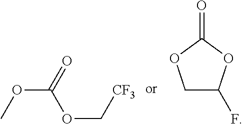

4. The lithium ion cell of claim 1, wherein the fluorinated solvent is a mixture of fluoroethylene carbonate, methyl 2,2,2-trifluoroethyl carbonate, and 1,1,2,2-tetrafluoroethyl-2,2,3,3-tetrafluoropropyl ether in a volume ratio of 3:5:2.

5. The lithium ion cell of claim 1, wherein the cathode active material has an operating voltage from 4.6 volts to 5.3 volts.

6. The lithium ion cell of claim 1, wherein the cathode active material has an operating voltage from 4.8 volts to 5.2 volts.

7. The lithium ion cell of claim 1, wherein the cathode active material has an operating voltage from 4.9 volts to 5.2 volts.

8. The lithium ion cell of claim 1, wherein the cathode active material comprises
Liₓ(M¹_{y}Mn_{2-y})O₄, Liₙ(M²_{y}M³_{2-y})(XO₄)₃, LiM²_{z}M³_{1-z}XO₄, or
LiM²_{z}M³_{1-z}ZO₄LiR¹ₐR²₁₋ₐ, wherein M¹ is Cr, Fe, Co, Ni, or Cu, M² is Fe, Co, Mn, Ti, V, or Ni, M³ is different from M² and is Fe, Co, Mn, Ti, V, or Ni, X is S, P, As, Mo or W, Z is P or S, R¹ is O, OH, F, Cl, Br or I, R² is different from R¹ and is O, OH, F, Cl, Br or I, 0<x≦2, 0<y≦2, 0<z<1, 0<n≦3, and0≦a≦1.

9. The lithium ion cell of claim 1, wherein the cathode active material is LiCr_{0.5}Mn_{1.5}O₄, LiCrMnO₄, LiFe_{0.5}Mn_{1.5}O₄, LiCo_{0.5}Mn_{1.5}O₄, LiCoMnO₄, LiCoMnO₄, LiNi_{0.5}Mn_{1.5}O₄, LiNiPO₄, LiCoPO₄, LiMnPO₄, or LiCoPO₄F.

10. The lithium ion cell of claim 1, wherein the cathode active material is LiMn_{0.33}Fe_{0.33}Co_{0.33}PO₄, and Li_{2.02}Co_{0.64}Mn_{3.34}O₈, or LiCoSO₄F.

11. The lithium ion cell of claim 8, wherein 1<x≦2.

12. The lithium ion cell of claim 8, wherein the lithium additive comprises a cathode active material with excess stoichiometric ratio (1<x≦2).

13. The lithium ion cell of claim 12, wherein the lithium additive comprises a cathode active material of Li₂Ni_{0.5}Mn_{1.5}O₄.

14. The lithium ion cell of claim 1, wherein the lithium additive comprises a sacrificial cathode active material selected from the group consisting of Li₂MnO₃, Li₅FeO₄, and Li_{x′}(Met)O₂, wherein Met is a mixture of Ni, Co, and Mn and 1<x′≦2.

15. The lithium ion cell of claim 1, wherein the anodic material is a carbon material, a silicon material, or an alloy-forming material.

16. The lithium ion cell of claim 1, wherein the anodic material comprises one or more of synthetic graphite, carbon-coated natural graphite, hard carbon, soft carbon, or mesocarbon microbeads (MCMB).

17. The lithium ion cell of claim 1, wherein the lithium additive comprises an organolithium material comprising a lithium terephthalate carboxylate, lithium isatine, dilithium pyromellitic diimide, tetralithium salt of tetrahydroxybenzoquinone (Li₄C₆O₆), an aryl lithium, 2-(phenylsulfonyl)-propan-2-yl lithium, 2-(phenylsulfinyl)-propan-2-yl lithium, 2-cyanopropan-2-yl lithium, 2-(diethoxyphosphoryl)propan-2-yl lithium, lithium-2-carboxylatopropan-2-yl lithium, furanyl lithium, thiophenyl lithium, lithium diisopropylamine, lithium bis(trimethylsilyl)amide, or lithium tetramethylpiperidide.

18. The lithium ion cell of claim 1, wherein the lithium additive comprises a lithium metal foil.

19. The lithium ion cell of claim 1, wherein the anode comprises a current collector having an obverse surface and a reverse surface, with the anode material is in contact with the obverse surface and the lithium metal foil is proximal to the reverse surface.

20. The lithium ion cell of claim 1, wherein the anode comprises a current collector having an obverse surface and a reverse surface, with the anode material is in contact with the obverse surface and the lithium metal foil is proximal to the anodic material.

21. A lithium ion cell comprising:
a cathode comprising a cathode active material having an operating voltage of 4.6 volts or greater;
an anode comprising a lithium silicon alloy; and
a separator; and
an electrolyte comprising a lithium salt and a solvent comprising
fluoroethylene carbonate, methyl 2,2,2-trifluoroethyl carbonate, and 1,1,2,2-tetrafluoroethyl-2,2,3,3-tetrafluoropropyl ether in a volume ratio of 3:5:2.
